(19) United States
(12) Patent Application Publication
(10) Pub. No.: US 2026/0264334 A1
(43) Pub. Date: Sep. 10, 2026

(54) METHOD AND SYSTEM FOR THREE-DIMENSIONAL (3D) PRINTING USING INTERLAYER STITCHING

(71) Applicant: THE GOVERNORS OF THE UNIVERSITY OF ALBERTA, Edmonton (CA)

(72) Inventors: Ahmed QURESHI, Edmonton (CA); Ahmed ELSHERBINY, Edmonton (CA); Pierre MERTINY, Edmonton (CA); David NOBES, Edmonton (CA)

(21) Appl. No.: 19/165,439

(22) PCT Filed: Mar. 22, 2024
(86) PCT No.: PCT/CA2024/050349

§ 371 Date: Sep. 15, 2025

Related U.S. Application Data
(60) Provisional application No. 63/492,120, filed on Mar. 24, 2023.

(51) Int. Cl. B29C 64/386; B29C 64/118; B33Y 10/00; B33Y 50/00; B33Y 80/00

(52) U.S. Cl. CPC B29C 64/386; B29C 64/118; B33Y 10/00; B33Y 50/00; B33Y 80/00

(57) ABSTRACT

Embodiments herein generally relate to methods and systems for three-dimensional (3D) printing, using interlayer stitching. In at least one embodiment, there is provided a method for printing a three-dimensional (3D) part using interlayer stitching, comprising: segmenting a 3D part model into a plurality of 3D subblocks, to generate a segmented 3D part model, wherein at least some subblocks are stitch subblocks that comprise one or more arm portions for connecting to other subblocks; and operating a 3D printer to print a stitched 3D part, based on the segmented 3D part model.

### CROSS-RELATED REFERENCE(S)

The present application claims the priority benefit of U.S. Provisional Application 63/492,120, filed on Mar. 24, 2023, the entire contents of which are incorporated herein by reference.

### FIELD

The present invention generally relates to using additive manufacturing and three-dimensional (3D) printing techniques, and more particularly, to a method and system for three-dimensional (3D) printing using interlayer stitching. In some examples, the method and system are performed using fused deposition modeling (FDM) 3D printers.

### BACKGROUND

Over recent years, the demand for additive manufacturing (AM) technology has significantly increased. This includes increased demand in the automotive, aerospace, biomedical, fashion, and military industries. AM technology has gained popularity due to its flexibility in both the design and fabrication stages, along with its exceptional capability of prototyping with low cost and less tool complicity.

To that end, fused deposition modelling (FDM) 3D printing is a fast-growing AM technology that provides a vital contribution to modern-day manufacturing. In particular, FDM offers a large economic and environmental implications in terms of cost, quality, functionality, and sustainability.

### SUMMARY OF VARIOUS EMBODIMENTS

In at least one broad aspect, there is provided a method for printing a stitched three-dimensional (3D) part using a 3D printer, the 3D part extending along a vertical axis, between a lower end and an upper end, the method comprising: segmenting the 3D part model into a plurality subblocks including a plurality of: (i) interstitial subblocks; and (ii) stitch subblocks, wherein each stitch subblock comprises a stitch element having a staircase configuration that extends along a diagonal axis vertically offset from the vertical axis, and the interstitial subblocks support the stitch subblocks, operating the 3D printer to control a printer nozzle to print the stitched 3D part by printing the interstitial subblocks and stitch subblocks.

In another broad aspect there is provided, a stitched three-dimensional (3D) part extending along a vertical axis, between a lower end and an upper end, comprising: a plurality subblocks including a plurality of: (i) interstitial subblocks; and (ii) stitch subblocks, wherein each stitch subblock comprises a stitch element having a staircase configuration that extends along a diagonal axis vertically offset from the vertical axis, the interstitial subblocks support the stitch subblocks, and each subblock comprises one or more extruded filament lines.

In some examples, each stitch element, in a stitch subblock, comprises one or more arm pairs, each arm pair comprising: a first arm; a second arm; and an arm linkage coupling the first and second arms.

In some examples, each stitch element comprises a plurality of arm pairs extending along a first horizontal axis.

In some examples, each of the first and second arms comprises a horizontal terminal segment; a horizontal mid-segment; a vertical segment, extending along the vertical axis, and coupling together: (i) the horizontal terminal segment, and (ii) the horizontal mid-segment, wherein, each of the horizontal segments extends along a second horizontal axis, and the first and second arm are spatially offset along the first horizontal axis.

In some examples, the vertical segments, of each arm, extend in opposing directions along the vertical axis; and the horizontal mid-segments and terminal segments, of each arm, extend in opposing directions along the second horizontal axis.

In some examples, to provide the staircase configuration for the stitch element, the horizontal mid-segments, in each arm, extend along a common horizontal plane, and are coupled together by the arm linkage, and the horizontal terminal segments, in each arm, extend in different horizontal planes disposed vertically above and below the common horizontal plane.

In some examples, operating the 3D printer to print the stitch element comprises controlling the printer nozzle to position the nozzle along the common horizontal plane; and control the nozzle to print the first arm, followed by the arm linkage portion and followed by the second arm.

In some examples, the 3D part model is segmented into a plurality of stitch subblocks forming one or more extended staircase configurations, each of the one or more extended staircases being formed by arranging the stitch subblocks to extend along a diagonal axis, angularly offset from the vertical axis, wherein, the horizontal terminal segments of each arm, in one stitch subblock, is offset and staggered between the horizontal terminal segments of each arm in another stitch subblock along the first horizontal axis.

In some examples, the plurality of stitch subblocks comprise: (i) first stitch subblocks having a left-handed stitch element; and (ii) second stitch subblocks having a right-handed stitch element, wherein the left-handed and right-handed stitch elements are non-superimposable mirror images of each other with respect to the relative positioning of the first and second arms.

In some examples, one or more extended staircase configurations comprise, at least one left-handed staircase configuration formed by an arrangement of the first subblocks; and at least one right-handed staircase configuration formed by an arrangement of the second subblocks.

In some examples, the left-handed and right-handed staircase configurations are interlocked such that the horizontal mid-segment of the stitch elements in the left-handed staircase are disposed and offset, along the first horizontal axis, between the horizontal mid-segment of the stitch elements in the right-handed staircase.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an illustration of an example fused deposition modelling (FDM) three-dimensional (3D) printing system.

FIG. 2A is a side view illustration of layer-by-layer filament deposition for 3D printing of a part.

FIG. 2B is a top view illustration of layer-by-layer filament deposition for 3D printing of a part.

FIG. 3A is an example three-dimensional (3D) part model.

FIG. 3B is an example outer contour subblock.

FIG. 3C is an example interstitial subblock.

FIG. 3D is an example base portion of a 3D part model.

FIG. 3E is an example 3D part model and illustrating the outer contour regions and the in-fill region.

FIG. 3F is an example stitched 3D part model.

FIG. 3G is a side view of the stitched 3D part model of FIG. 3F.

FIG. 4A is an example “left-handed” stitch subblock.

FIG. 4B is an example “right-handed” stitch subblock.

FIG. 4C is an example YZ plane cross-sectional view of one or more stitch blocks, extending along the Y-axis.

FIG. 5 is an example toolpath for depositing a stitch element.

FIG. 6A is a partially printed 3D part and showing two right-handed stitch subblocks.

FIG. 6B is a side view of the partially printed 3D part of FIG. 6A.

FIG. 7A is a partially printed 3D part, and further showing a combination of right-handed and left-handed stitch subblocks.

FIG. 7B is a side view of the partially printed 3D part, of FIG. 7A.

FIG. 7C shows a partial view of the printed 3D part.

FIG. 8A shows, along a vertical plane (i.e., YZ plane), a configuration of right and left-handed stitch elements.

FIG. 8B shows, along a vertical plane (i.e., YZ plane), a configuration of right and left-handed stitch elements.

FIG. 9 shows an example method for printing a three-dimensional (3D) part using interlayer stitching.

FIGS. 10A to 10D illustrate various stages of a method for 3D printing using interlayer stitching.

FIG. 11 shows various images of side, top and cross-sectional views of an example sample 3D part printed using an interlayer stitching technique, in accordance with embodiments disclosed herein.

FIG. 12 is a plot showing the results of a tensile test of a sample 3D part, printed using the interlayer stitching technique disclosed herein.

FIG. 13 is a simplified hardware block diagram of an example system for 3D printing using interlayer stitching.

### DETAILED DESCRIPTION OF THE EMBODIMENTS

### I. Definitions

Any term or expression not expressly defined herein shall have its commonly accepted definition understood by a person skilled in the art. As used herein, the following terms have the following meanings.

“Additive Manufacturing (AM)” is generally known in the art and refers to a set of manufacturing techniques which involve depositing layer-by-layer material to create a net shape part. In many cases, the manufacturing or building process is based on a virtual model generally generated using computer assisted design. Examples of additive manufacturing include three-dimensional (3D) printing and rapid prototyping.

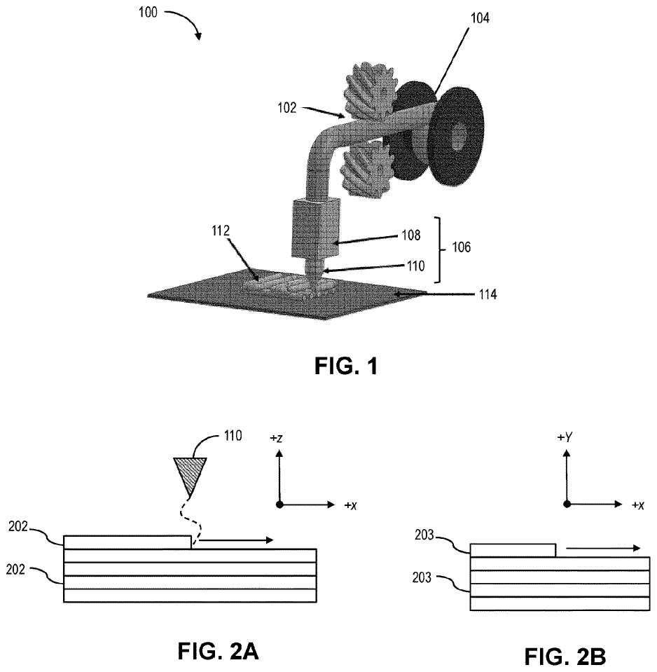

“Fused Deposition Modelling (FDM)” (also known as “Fused Filament Fabrication (FFF)”) refers to an AM technique in which the filaments are extruded through a heated nozzle and deposited over a platform, layer-by-layer, to print 3D models, as shown in FIGS. 1 and 2.

“Interlayer Stitching” refers to bonding together of vertical layers of a 3D printed part using stair-cased and/or z-shaped printed elements.

“Processor” refers to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors.

“Memory” refers to a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

### II. General Overview

FDM is a three-dimensional (3D) printing technique that utilizes a layer-by-layer construction process. FIG. 1 shows an example FDM printer system (100). FDM system (100) generally includes a feeding mechanism (102), connected to a filament spool (104). One end of the feeding mechanism (102) is further connected to a deposit assembly (106). Deposition assembly (106) can include a heater block (108) and an extruder nozzle (110). In use, filament, which could be a homogenous polymer, or a composite consisting of a polymer and chopped fiber, or continuous co-extruded fiber, is heated by the heater block (108). Subsequently, the heated filament is extruded through the nozzle (110) and deposited as deposit material (112) over a build platform (114).

As illustrated in FIGS. 2A and 2B, FDM typically prints 3D parts using layer-by-layer deposition (e.g., layers (202)). The deposition starts from the bottom layers and prints the 3D part upwardly.

More generally, FDM runs through a sequence starting from: (i) developing a 3D part model—this can be developed using any modelling software (e.g., any CAD software, including SolidWorks®, Inventor® and the like); (ii) converting the 3D model into horizontal layers, such that it is in a printable format (e.g., using a slicer software); (iii) generating an executable code for the 3D printer (e.g., G-Code or other software code); (iv) exporting the executable code to the 3D printer; (v) setting one or more printing parameters (e.g., ensuring printer nozzle and bed temperature are reached before printing starts); (vi) executing the code, by the printer, to print the 3D part; and (vii) in some cases, preforming post-processing to enhance the mechanical performance of the 3D part (e.g., annealing and consolidation).

As FDM technology is still in its early stages of development, the technology suffers from challenges including non-uniformity and non-homogeneity of the printed material, orientation-dependent applications, surface quality and anisotropic properties of the 3D part.

An important consideration of an FDM printing process, however, is the interlayer (202) and intralayer (203) adhesion bonding. These adhesion bonding directly contributes to the anisotropic properties and the mechanical performance of the 3D printed structure. Poor bonding between layers leads to weak mechanical properties along the vertical axis (i.e., Z-axis). Similarly, week bonding between beads throughout each layer leads to different mechanical properties along the planar axis (i.e., X-axis and Y-axis).

Embodiments herein provide for a printing technique that enhances interlayer as well as intralayer adhesion bonding, and hence, improves overall mechanical characteristics of the 3D printed parts. As described, this is realized using a toolpath that produces interlayer “stitching”. The interlayer stitching bonds together different layers, thereby enhancing mechanical strength.

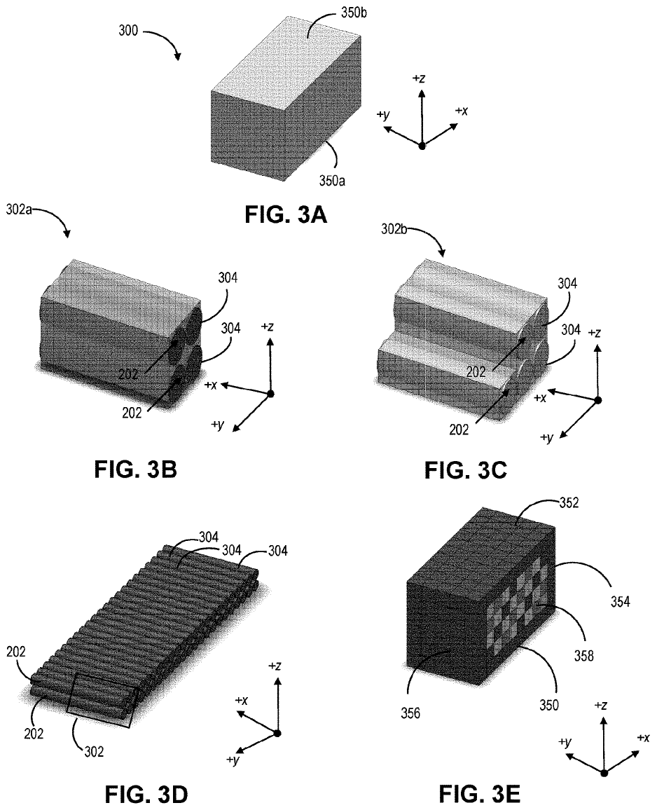

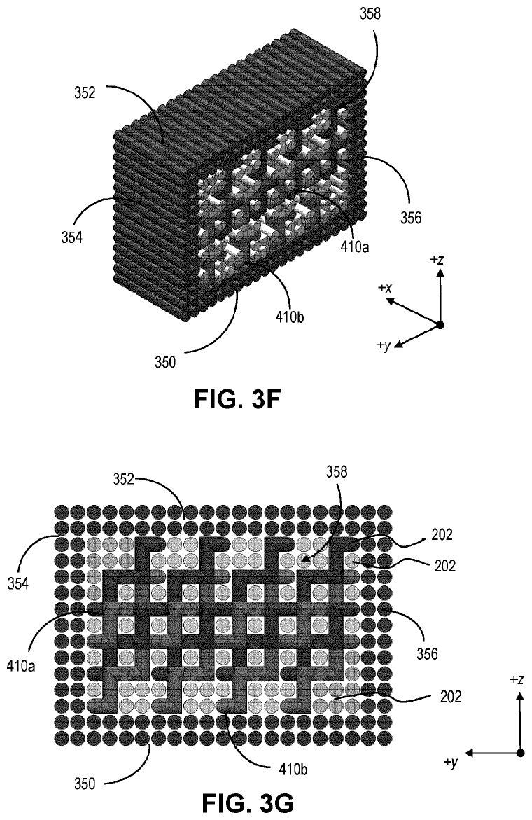

At a general level, as shown in FIGS. 3A-3C, the printing process involves, initially, accessing a 3D part model (300) (FIG. 3A). The 3D part model is the part(s) which is desired to be printed. In some examples, the 3D part model is a CAD® file. Generally, the 3D part model (300) extends along a vertical axis (Z-axis) between a lower end (350a) and an upper end (350b). When the 3D part (300) is printed, it is printed along the vertical axis between the lower and upper ends. In this manner, the vertical axis is also referred to as the printing axis. The 3D model is then segmented into a plurality of non-overlapping 3D subblocks, to generate a segmented 3D model. This is distinguished from a conventional case, where the 3D model is only initially sliced into horizontal layers (FIGS. 2A and 2B).

The 3D subblocks can have any desirable shape or configuration, provided it comprises at least two horizontal faces and at least four vertical faces. FIGS. 3B and 3C exemplify different shapes of 3D subblocks. These include a rectangular prism subblock (302a) (FIG. 3B), a non-rectangular subblock (302b) (FIG. 3C) and a cuboid subblock (not shown).

In some embodiments, each subblock is composed of one or more layer lines (304). As used herein, a “layer line” refers to a single line (e.g., linear or non-linear line) of filament material deposited by the printer's nozzle and having a thickness equal to the extruded filament. A “layer” comprises a plurality of “layer lines” in the same horizontal plane (e.g., the XY plane) and therefore has a vertical dimension equal to the height of one layer line.

For example, FIG. 3D shows a portion of a 3D part. This part is composed of two vertically stacked layers (202). Each layer (202), in turn, includes multiple layer lines (304). The layer lines may be deposited individually, or deposited in continuous fashion (e.g., as a continuous zigzag).

As referred to herein, the YZ plane corresponds to a vertical plane, that extends along the vertical axis. The XY plane corresponds to a horizontal plane, orthogonal to the vertical printing axis (e.g., the plane along which filament layers extend).

In the exemplified embodiment, the layer lines (304) extend along the X-axis. However, in other examples, the layer lines (304) can extend in any other direction along the XY plane. For example, the lines can extend along the Y-axis. To that end, in FIG. 3D, a subblock (302) is defined to include one or more layer lines (304) and/or layers (202).

Each subblock (302) can also have any suitable dimension. For example, each subblock can comprise any number of layers (202) in the vertical direction (i.e., Z-axis). For example, FIG. 3B extends vertically by two layers (202). Further, FIG. 3C extends vertically by two layers (202) in one area, and by only a single layer (202) in another area. Accordingly, it is understood that the subblock dimensions can vary, within the subblock (302). More generally, each subblock (302) can have one or more dimensions along each axis. In some examples, each subblock (302) is comprised of no more than two layer lines (202) along the vertical axis. In some examples, using smaller subblocks (302) allows for greater granularity in allocating different areas of the part model to different types of subblocks (302).

Each subblock (302) can also extend by any suitable length in the X- and Y-axis directions. For instance, in the X-direction, the subblock (302) can only extend along a portion of the length of a layer line. In the Y-direction, the subblock (302) can extend any number of layer lines (304).

In embodiments disclosed herein, the subblocks may be of different types, or classes. These include: (i) stitch subblocks; (ii) interstitial subblocks; and (iii) outer contour subblocks.

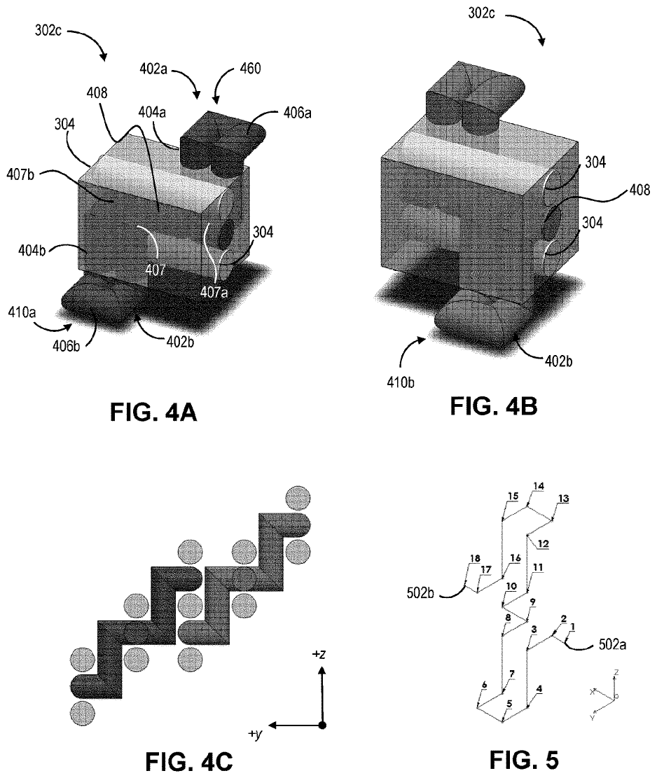

(i) Stitch Subblocks: Stitch subblocks couple together other subblocks, thereby allowing interlayer bonding. FIGS. 4A and 4B illustrate two different stitch subblocks (302c). As shown, each stitch subblock (302c) includes one or more arms (402a) which extend horizontally in the XY plane (402b). Each arm (402a), (402b) couples to surrounding (or adjacent) subblocks. The “staircase” design of the stitch subblock (302c) allows it to couple to subblocks vertically above and below the stitch subblock. In effect, this enables “stitching” vertically adjacent layers of the 3D part model together, for enhanced interlayer bonding.

FIGS. 3F and 3G illustrate how the stitching subblocks (302c) may be incorporated into the printed 3D part. FIG. 3F shows the “stitched” 3D model in perspective view, while FIG. 3G shows the stitched model from a side view. It is believed that the illustrated stitched 3D part includes better adhesion between layers and reduces the anisotropy of the printed part.

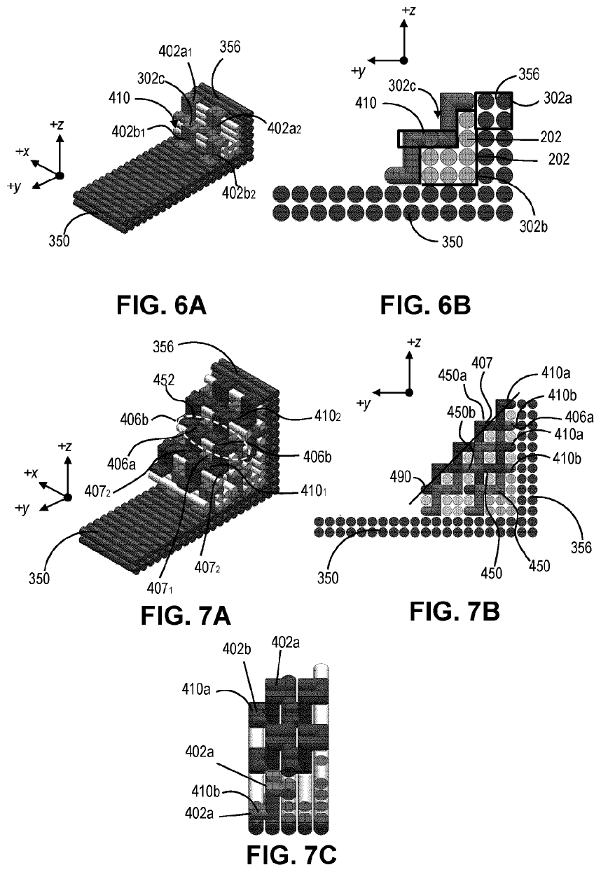

(ii) Interstitial Subblocks: Interstitial subblocks support stitch subblocks, while at the same time linking together stitch subblocks. FIG. 3C exemplifies a interstitial subblock (302b). FIG. 6B shows an example interstitial subblock (302b), used for supporting a stitch subblock (302c). In some examples, the interstitial subblocks have a shape configuration that is inverted to the stitch subblocks (e.g., an inverted staircase, as shown in FIG. 3C), at least along one face of the subblock. In this manner, the stitch subblocks (302c) can be layered over the interstitial subblocks (302b) in mating configuration. In some examples, the interstitial subblocks (302b) can comprise at least one layer line that fills the gap between two stitch subblocks. More generally, any gap between stitch subblocks (302c), or between stitch subblocks (302c) and other subblocks, can be filled with interstitial subblocks (302b).

(iii) Outer Contour Subblocks: These subblocks can be used to build the outer profile, or contour, of the 3D part model. For example, in FIG. 3E, the outer contour can include the lower base region (350), upper ceiling region (352) and the sidewalls (354), (356). FIG. 3B exemplifies an outer contour subblock (302a).

In some examples, the (i) stitch subblocks, and (ii) the interstitial subblocks, are only applied to an in-fill region of the 3D part. The in-fill region (358) is defined within the outer contour (see e.g., FIGS. 3E-3F). In other examples, there is no differentiation made between the outer contour and the in-fill region. In this case, the block (i) and (ii) can be applied anywhere, and the model may not necessarily include the outer contour subblocks.

In view of the foregoing, as contrasted to other methods for printing 3D parts—the disclosed embodiments rely on segmenting the 3D model into 3D subblocks, rather into only horizontal layers (FIG. 2). Further, one or more of the 3D subblocks define “stitch” subblocks, which are used for enhanced interlayer bonding.

While the methods (and systems) described herein primarily reference FDM printing, it will be understood that the same methods, concepts and principles can be applied to any other printing technique capable of depositing materials (e.g., fused filament fabrication (FFF), direct energy deposition (DED), fused granulated fabrication (FGF) and the like).

### III. Example Stitch Subblock

The following is a description of an example stitch subblock, that can be used in printing stitched 3D parts. The stitch subblock can be used alone, or in any combination or sub-combination with any elements or features described herein.

FIGS. 4A and 4B illustrate an example stitch subblock (302c). At a general level, as best shown in FIG. 4A, each stitch subblock (302c) extends along a diagonal axis (490) (e.g., along the YZ plane), that is angularly offset from the vertical printing axis (FIG. 7B).

Each stitch subblock has a staggered stair-cased, or z-shaped, configuration. More particularly, each stitch subblock (302c) includes a stitch element (410) that includes one or more arm pairs (460), whereby each arm pair (460) includes: (i) a first arm portion (402a); (ii) an opposing and horizontally offset, second arm portion (402b); and (iii) an arm linkage portion (408).

Each of the first and second arm portions (402a) and (402b) is configured in a “Z-shape”. More generally, each arm portion (402a), (402b) includes two horizontal extension segments (406), (407) coupled together by a vertical extension segment (404). The vertical and horizontal segments (404), (406), of each arm, are oriented oppositely to provide for the “staircase” (or z-shaped) configuration.

For instance, first arm portion (402a) include a vertical segment (404a) extending along the +Z-axis direction, and which couples together two horizontal segments (406a), (407a) extending along the −Y-axis direction. The horizontal segments include a horizontal terminal segment (406a) and a horizontal mid-segment (407a). The horizontal terminal segment (406a) is disposed vertically above the horizontal mid-segment (407a).

In contrast, the second arm portion (402b) includes a vertical segment (404b) extending along the −Z-axis direction, and which couples together two horizontal segments (406b), (407b) extending along the +Y-axis direction. The horizontal segments include a horizontal terminal segment (406b) and a horizontal mid-segment (407b). The horizontal terminal segment (406b) is disposed vertically below the horizontal mid-segment (407b).

As exemplified, the horizontal mid-segments (407a), (407b), of each arm (402), are coupled together via an arm linkage section (408). In this manner, the arm linkage (408) couples together the first and second arms (402a), (402b). The arm linkage (408) can couple the first and second arms (402a) and (402b), such that they are horizontally offset along the horizontal X-axis.

In this example, the stitch element (410) only include one arm pair (460). In other examples, however, the stitch element (410) is extended to include any desired number of arm pairs (460) extending along the horizontal X-axis. For example, in FIG. 6A, the stitch element (410) include two arm pairs (402a₁), (402b₁) and (402a₂), (402b₂).

FIG. 5 shows an example toolpath trajectory, to generate an example stitch element (410) comprising a single arm pair (460). This trajectory allows for the stitch element (410) to be printed using a continuous, undisrupted toolpath.

The order of movement of the toolpath, in FIG. 5, is illustrated through the numbering (i.e., 1 to 18). As shown, the toolpath can start and end, along the same horizontal plane that comprises the horizontal mid-segment (407a), (407b) and arm linkage (408). The start and end points (i.e., 1 and 18) define the “terminal ends” (502a), (502b) of the stitch element (410). In this example, the toolpath begins at the terminal end (502a), prints a first arm, followed by the arm linkage (408) and further followed by a second arm. In some examples, each arm (402) has a thickness of two or more deposition layers.

At the terminal ends (502a), (502b), the toolpath can continue to print a next, or adjacent arm pair (460), such that there are multiple arm pairs (460) adjacent to each other along the horizontal X-axis (e.g., FIG. 6A). This allows for continuous printing of an elongated stitch element (410) in a single stitch subblock (302c). This is desirable, for example, where the stitch element (410) is extended to cover width of the 3D model, e.g., along the X-axis.

As previously stated, the stitch subblocks (302c) couple to adjacent subblocks, via the arms (402a), (402b). Any exposed surface of the arms (e.g., exposed surface of any arm segment (404), (406), (407)) can couple (e.g., engage) to any other portion, of any other subblock (or more generally, any other portion of the 3D model). For example, the exposed surfaces of the vertical and/or horizontal segments (404), (406), (407) of each arm, can couple to other subblocks (FIG. 4A).

To clarify this concept, reference is made to FIGS. 6A and 6B. These figures illustrate a partially assembled 3D part, shown in both perspective view (FIG. 6A) and a side view (FIG. 6B).

In this example, a subblocks (302c) is printed with a stitch element (410) extending and covering the width of the 3D part, i.e., extending along the horizontal X-axis.

The stitch element (410) couples to adjacent subblocks (302). For example, as shown in FIG. 6B, this includes coupling to the stitch element (410), along its exposed surfaces, to the interstitial subblocks (302b) that supports the stitch element (410) (FIG. 3C). It can also include coupling the stitch element (410) to outer contour subblocks (302a).

It is appreciated from FIGS. 6A and 6B, that the stitch subblock (302c) allows for coupling multiple vertical layers (202). This promotes better inter-layer adhesion.

FIGS. 7A and 7B show a further printed 3D part, showing the assembly of additional stitch subblocks (302c).

As shown in FIG. 7B, the stitch subblocks (302c) can be vertically stacked, to couple to still additional vertical layers (202). In the exemplified embodiments, the stitch blocks (302c) are also arranged to form extended staircase patterns, e.g., along the YZ plane. As used herein, an “extended staircase” refers to a sequenced arrangement of two or more stitch subblocks, arranged to extend diagonally (e.g., along a diagonal staircase axis (490) (FIG. 7B) extending in the YZ plane and angularly offset from the vertical axis, e.g. by a 450 angle), to form an elongated staircase configuration of the stitch elements (410).

For example, in FIG. 7B, observed along the vertical YZ plane, there are four extended staircases (450) extending along parallel diagonal staircase axes. In each extended staircase (450), the stitch elements (410) are arranged along a respective diagonal staircase axis defined along the YZ plane, such that along the respective staircase axis, one stitch element (410) begins where the previous stitch element (410) ends, and with some degree of overlap. Observed in perspective view (FIG. 7A), the staircase effect is produced by aligning and staggering (e.g., offsetting) the horizontal arm segments (406), of various stitch element (410) in the staircase, along a common horizontal plane.

For example, FIG. 7A shows two stitch elements (410₁) and (410₂) forming an extended staircase. Stitch elements (410₁) is disposed along a first horizontal plane, and stitch elements (410₂) is disposed along a second horizontal plane. The second horizontal plane is vertically disposed above the first horizontal plane.

As shown, the staircase arrangement is achieved by disposing and staggering the horizontal terminal arm segment (406), in one stitch element (410₁), between the horizontal terminal arm segments (406) of the other stitch element (410₂) (e.g., along the X-axis). In some examples, as best shown in FIG. 7A, the horizontal segments (406a), (406b) (e.g., as shown in the area (452)) are not only staggered but are dimensioned to mate with each other. For instance, horizontal arm segment (406a) of first stitch element (410₁), is dimensioned to fit between horizontal arm segments (406b), of second stitch element (410₂). In this manner, the stitch elements (410) cover the entire area (452), along the X-axis.

A few points are appreciated by the use of the extended staircase configuration: (i) first, the extended staircase allows multiple stitch elements (410) to extend vertically between different horizontal deposition layers (202), thereby providing enhanced structural adhesion between these layers. This effect is enhanced by printing more than one extended staircase (450) (FIG. 7B), along spaced and parallel diagonal axes, e.g., thereby allowing better binding together of different portions of the horizontal deposition layers (202); and (ii) further, the staggered and mating configuration of the stitch elements (410) (e.g., area (452) in FIG. 7A), in each extended staircase (450) allows the horizontal arm segments (406), in a stich element (410), to cover the width dimension of the 3D part (e.g., along the X-axis), which allows for better adhesion of the stitch element (410) to different layers (202).

### IV. Direction-Specific Stitching Elements

In some examples, two different types of stitch elements (410) are used in different stitch subblocks (302c). These include: (i) left-handed stitch elements (410a) (FIG. 4A); and (ii) right-handed stitch elements (410b) (FIG. 4B). The difference between the two stitch elements is in the toolpath direction. A left-handed stitch element and a right-handed stitch element are non-superimposable mirror images of each other with respect to the relative positioning of the first and second arms (402a), (402b), e.g., analogous to chemical enantiomers.

FIGS. 7A and 7B show an example combination of stitch subblocks (302c), using both left-handed and right-handed stitch elements (410a, 410b). FIGS. 3F and 3G show a final printed 3D part, including both types of stitch subblocks.

In some examples, as shown in FIGS. 7A and 7B, the extended staircases (450) are alternated between staircases (450) formed of right-handed stitch elements and left-handed stitch elements. This produces a fully interlocking effect between the stitch elements (410), as explained herein.

In this configuration, the right- and left-hand stitch elements can be arranged, such that the horizontal mid-segments (407), of each right- or left-handed stitch elements, mate and interlock with each other.

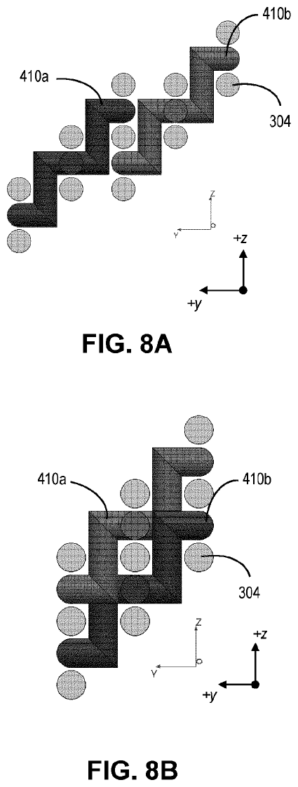

This is shown, for example, in FIG. 7A. As shown, the right-stitch (410b) has an arm having a horizontal mid-segment (407₁) that is offset along the X-axis and disposed between, the horizontal mid-segments (407₂) of two left-hand stitch elements. These segments can be dimensioned to mate with each other in abutting relation. The appreciated advantage of using different directional stitches, and in the exemplified patterned configuration, is best appreciated with reference to FIGS. 8A and 8B. FIGS. 8A and 8B show cross-sectional illustrations of the combined applied stitching (e.g., left-hand and right-hand) along two different cross-sectional views, generated along the YZ plane.

In FIG. 8A, it is observed that that if the right-hand stitch (410b) is pulled along the +Z-direction, then it encounters a mechanical resist (e.g., interlocking) from the left-hand stitch (410a), which is already interlocked with other material in a different layer. Similarly, in FIG. 8B, if the right-hand stitch (410b) is pulled along the +Y-direction, it also encounters a mechanical resist from the left-hand stitch (410a). Accordingly, by implementing this dual stitching technique, each couple of layers is expected to have a strong bonding between layers.

Therefore, the dual-direction stitching technique—using direction-specific stitch elements (410)—can improve the interlayer bonding. In turn, this can significantly enhance the mechanical characteristics in the vertical axis (i.e., Z-direction) as well as reducing the mechanical anisotropy of the system. Hence, the printed parts can be independent to the printing orientation, which widens the application of 3D printing in the industrial level. This is contrasted to conventional printed parts, where due to the poor mechanical properties along the Z-axis direction. Typically, the printed part is to be oriented so that the direction of the loading is to be within the XY-plane.

### V. Example Method for Interlayer Stitching

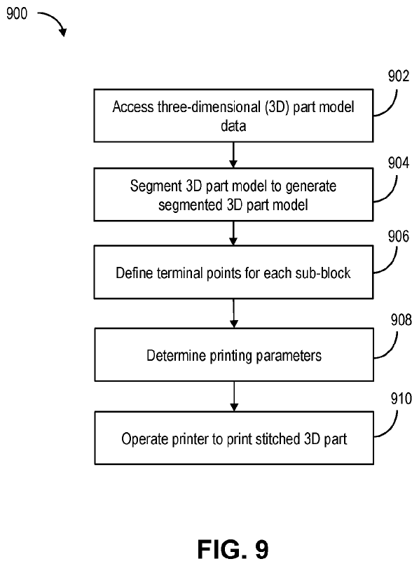

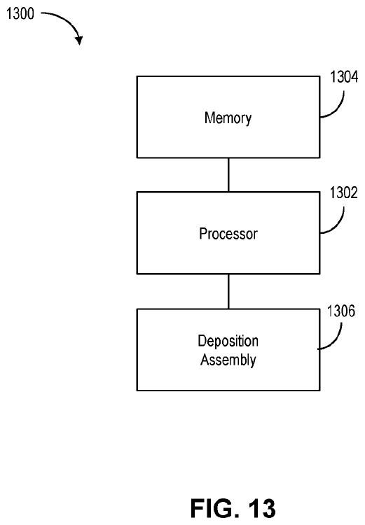

FIG. 9 shows an example method (900) for printing a three-dimensional (3D) part using interlayer stitching. Method (900) can be performed using a processor (e.g., processor (1302) of FIG. 13).

At (902), the three-dimensional (3D) part model data is accessed. For example, this can be 3D part (300) (FIG. 3A). In some examples, the 3D part data is in a CAD (Computer Aided Design) format, e.g., SolidWorks®, etc. The 3D model data can be stored on a memory, or otherwise, retrieved from an external computing device.

At (904), the 3D part is segmented into one or more subblocks to generate a segmented 3D part model (e.g., FIGS. 3B, 3C, 4A and 4B). The segmentation process can also involve assigning, or generating different types of subblocks. For example, some subblocks are generated as stitch subblocks (302c) (FIGS. 4A and 4B). In these cases, the subblocks include stitch elements (410). To that end, the system can generate any configuration or pattern of stitch subblocks. For instance, the system can generate the alternating configuration shown in FIGS. 8A and 8B, in which the stitch subblocks alternate between right and left handed stitch subblocks.

In some examples, the segmentation process involves defining a plurality of stitch subblocks (302c) forming one or more extended staircases (450). The extended staircases (450) can extend along respective staircase diagonal axis (490), as defined above. In some examples, each extended staircase (450) can extend between a lower end and an upper end of the part model. In other examples, if the part model includes outer contour subblocks that define the outer profile of the part model, then each extended staircase (450) extends between the outer profile defined by the outer contour subblocks (302a).

In some examples, the extended staircases (450) are alternated between staircases formed of stitch subblocks using left-handed and right-handed stitch elements, and in the above defined configuration.

The system can then allocate (e.g., designate) the areas between the stitch subblocks (302c)—or between the stitch subblocks (302c) and the outer counter subblocks (302a)—as interstitial subblocks (302b) that support the stitch subblocks (302c).

At (906), terminal points are defined for each subblock, for further processing (e.g., next act). The terminal points define points from which each pattern will start to print.

At (908), a pre-processing calculation are executed to define different printing variables. For example, the printing variable can relate to stitch dimensions based on the nozzle diameter, material deposition rate, layer height, travel distance in each direction, nozzle travel sped, filament overlapping.

At (910), the 3D printer is operated to print the 3D part using interlayer stitching. This can involve generating an executable code (e.g., G-code) for controlling the nozzle path. In some cases, the pre-printing script requires defining certain machine settings.

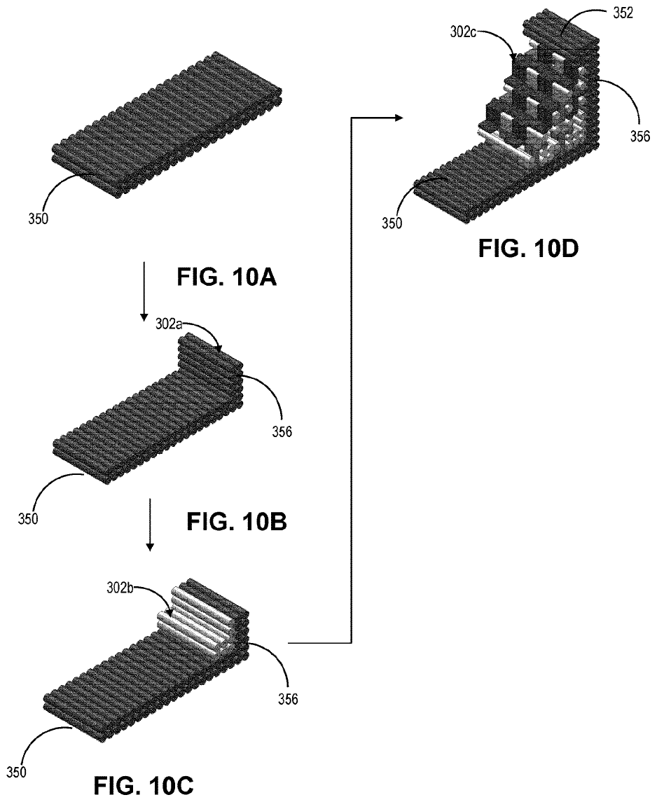

In some examples, printing the part starts with at least some contouring, which represents the outer shell of the part. For examples, in FIGS. 10A and 10B, a portion of the base (350) and sidewall (356) can be initially printed. These are printed using outer contour subblocks (302a). Subsequently, this is to be gradually followed by infill pattern, which presents the core of the printed part.

In some embodiments, an interstitial subblocks (302b) is printed before proceeding with the stitch subblock (302c) printing (see e.g., FIGS. 10C and 10D). This performs a dual function; first is to provide a support for the coming stitch subblock, while at the same time linking the stitch subblock with the previous stitch subblock.

The printing process can iterate continuously, whereby the in-fill region is printed while concurrently completing the outer contour region.

In at least one embodiment, the method additionally involves defining a post-printing script to cool down the machine and move the bed to a position away from the machine bed. This facilitates the printed part removal without damaging both the part and the nozzle.

### VI. Experimental Results

Multi-color samples were prepared using Original Prusa® i3 MMU2S. These samples were then sliced perpendicular to the cross-section and then scanned under the microscope to examine the morphology of the printed structure.

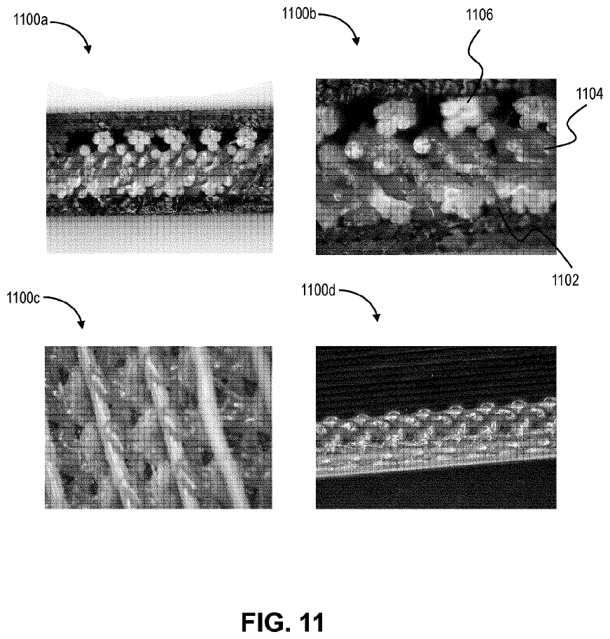

FIG. 11 shows different views of the printed part. The printed part is shown in a cross-sectional view generated along the YZ plane (1100a) and includes an enlarged cross-sectional view (1100b). The printed part is also shown from top view (1100c), and a 45° top view (1100d).

In these pictures, the different components of the technique are clearly noticed, each in a different color. In particular, it is noticed that the right-hand stitch (printed in red color)(1102) exists in different layers, the same applies to the left-hand stitch (printed in blue) (1104). The interstitial (printed in yellow) (1106) is also observed. From these figures, it is also noticeable the mixing up of colors between features, which means they are blended together for better adhesion in between layers.

ASTM D638 type I test samples were also prepared using Ender® 5 Pro. Two sets of samples were prepared: the first set was printed with the disclosed stitching technique, while the second set was printed as a comparison to the current slicing patterns. The rectilinear pattern was chosen based on the conclusion that this pattern reflects the highest mechanical properties among others.

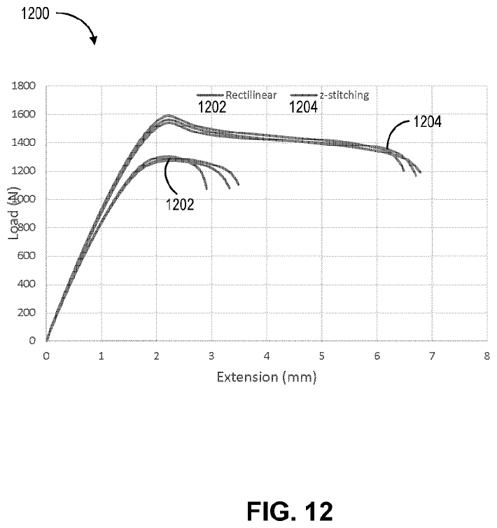

FIG. 12 shows a plot (1200) representing the tension test data of the two sets of samples, including tension data generated by a 3D part model printed using a simplified rectilinear configuration (1202) and a z-stitching configuration (1204) as disclosed herein. Here it is confirmed that the proposed technique not only provides a higher yield and tensile strength, but also longer elongation which reflects a higher energy absorption capability.

### VII. Example Hardware

FIG. 13 shows an example hardware configuration for an example FDM system (1300), that can be used in the disclosed embodiments. As shown, the system generally includes a processor (1302) coupled to one or more of a memory (1304) and a deposition assembly (1306). The deposit assembly (1306) can include the extruding nozzle (110), and in some cases, the heating element (108) (FIG. 1).

In some examples, the memory (1304) stores the 3D part requiring printing, and the method (900) is executed by the processor (1302). In other examples, a portion of the method (900) is executed on a separate computing device (e.g., a computer terminal and/or remote server). For example, acts (902)-(908) can be performed on a processor of a remote computing device and/or server, and act (910) is performed by processor (1302). In these examples, the 3D part model (act (902)), may be accessed from a memory of a separate computing device.

### VIII. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object-oriented programming or script-based programming. Accordingly, the program code may be written in Java, Swift/Objective-C, C, C++, Javascript, Python, SQL or any other suitable programming language and may comprise modules or classes, as is known to those skilled in object-oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A method for printing a stitched three-dimensional (3D) part using a 3D printer, the 3D part extending along a vertical axis, between a lower end and an upper end, the method comprising:
segmenting the 3D part model into a plurality subblocks including a plurality of: (i) interstitial subblocks; and (ii) stitch subblocks, wherein
each stitch subblock comprises a stitch element having a staircase configuration that extends along a diagonal axis vertically offset from the vertical axis, and
the interstitial subblocks support the stitch subblocks,
operating the 3D printer to control a printer nozzle to print the stitched 3D part by printing the interstitial subblocks and stitch subblocks.

2. The method of claim 1, wherein each stitch element, in a stitch subblock, comprises one or more arm pairs, each arm pair comprising:
a first arm;
a second arm; and
an arm linkage coupling the first and second arms.

3. The method of claim 2, wherein each stitch element comprises a plurality of arm pairs extending along a first horizontal axis.

4. The method of claim 2, wherein each of the first and second arms comprises:
a horizontal terminal segment;
a horizontal mid-segment
a vertical segment, extending along the vertical axis, and coupling together: (i) the horizontal terminal segment, and (ii) the horizontal mid-segment, wherein,
each of the horizontal segments extends along a second horizontal axis, and
the first and second arm are spatially offset along the first horizontal axis.

5. The method of claim 4, wherein,
the vertical segments, of each arm, extend in opposing directions along the vertical axis; and
the horizontal mid-segments and terminal segments, of each arm, extend in opposing directions along the second horizontal axis.

6. The method of claim 5, wherein to provide the staircase configuration for the stitch element,
the horizontal mid-segments, in each arm, extend along a common horizontal plane, and are coupled together by the arm linkage, and
the horizontal terminal segments, in each arm, extend in different horizontal planes disposed vertically above and below the common horizontal plane.

7. The method of claim 6, wherein operating the 3D printer to print the stitch element comprises controlling the printer nozzle to:
position the nozzle along the common horizontal plane; and
control the nozzle to print the first arm, followed by the arm linkage portion and followed by the second arm.

8. The method of claim 7, wherein the 3D part model is segmented into a plurality of stitch subblocks forming one or more extended staircase configurations, each of the one or more extended staircases being formed by:
arranging the stitch subblocks to extend along a diagonal axis, angularly offset from the vertical axis, wherein,
the horizontal terminal segments of each arm, in one stitch subblock, is offset and staggered between the horizontal terminal segments of each arm in another stitch subblock along the first horizontal axis.

9. The method of claim 8, wherein the plurality of stitch subblocks comprise: (i) first stitch subblocks having a left-handed stitch element; and (ii) second stitch subblocks having a right-handed stitch element, wherein the left-handed and right-handed stitch elements are non-superimposable mirror images of each other with respect to the relative positioning of the first and second arms.

10. The method of claim 9, wherein the one or more extended staircase configurations comprise,
at least one left-handed staircase configuration formed by an arrangement of the first subblocks; and
at least one right-handed staircase configuration formed by an arrangement of the second subblocks.

11. The method of claim 10, wherein the left-handed and right-handed staircase configurations are interlocked such that the horizontal mid-segment of the stitch elements in the left-handed staircase are disposed and offset, along the first horizontal axis, between the horizontal mid-segment of the stitch elements in the right-handed staircase.

12. A stitched three-dimensional (3D) part extending along a vertical axis, between a lower end and an upper end, comprising:
a plurality subblocks including a plurality of: (i) interstitial subblocks; and (ii) stitch subblocks, wherein
each stitch subblock comprises a stitch element having a staircase configuration that extends along a diagonal axis vertically offset from the vertical axis,
the interstitial subblocks support the stitch subblocks, and
each subblock comprises one or more extruded filament lines.

13. The part of claim 12, wherein each stitch element, in a stitch subblock, comprises one or more arm pairs, each arm pair comprising:
a first arm;
a second arm; and
an arm linkage coupling the first and second arms.

14. The part of claim 13, wherein each stitch element comprises a plurality of arm pairs extending along a first horizontal axis.

15. The part of claim 13, wherein each of the first and second arms comprises:
a horizontal terminal segment;
a horizontal mid-segment
a vertical segment, extending along the vertical axis, and coupling together: (i) the horizontal terminal segment, and (ii) the horizontal mid-segment, wherein,
each of the horizontal segments extends along a second horizontal axis, and
the first and second arm are spatially offset along the first horizontal axis.

16. The part of claim 15, wherein,
the vertical segments, of each arm, extend in opposing directions along the vertical axis; and
the horizontal mid-segments and terminal segments, of each arm, extend in opposing directions along the second horizontal axis.

17. The part of claim 16, wherein to provide the staircase configuration for the stitch element,
the horizontal mid-segments, in each arm, extend along a common horizontal plane, and are coupled together by the arm linkage, and
the horizontal terminal segments, in each arm, extend in different horizontal planes disposed vertically above and below the common horizontal plane.

18. The part of claim 17, wherein the 3D part model comprises a plurality of stitch subblocks forming one or more extended staircase configurations, each of the one or more extended staircases being formed by:
arranging the stitch subblocks to extend along a diagonal axis, angularly offset from the vertical axis, wherein,
the horizontal terminal segments of each arm, in one stitch subblock, is offset and staggered, along the first horizontal axis, between the horizontal terminal segments of each arm in another stitch subblock.

19. The part of claim 18, wherein the plurality of stitch subblocks comprise: (i) first stitch subblocks having a left-handed stitch element; and (ii) second stitch subblocks having a right-handed stitch element, wherein the left-handed and right-handed stitch elements are non-superimposable mirror images of each other with respect to the relative positioning of the first and second arms.

20. The part of claim 19, wherein the one or more extended staircase configurations comprise,
at least one left-handed staircase configuration formed by an arrangement of the first subblocks; and
at least one right-handed staircase configuration formed by an arrangement of the second subblocks, and
wherein the left-handed and right-handed staircase configurations are interlocked such that the horizontal mid-segment of the stitch elements in the left-handed staircase are disposed and offset, along the first horizontal axis, between the horizontal mid-segment of the stitch elements in the right-handed staircase.
